(19) United States
(12) Patent Application Publication
(10) Pub. No.: US 2024/0426365 A1
(43) Pub. Date: Dec. 26, 2024

(54) VIBRATION-DAMPING SYSTEM

(71) Applicant: SUMITOMO RIKO COMPANY LIMITED, Komaki-shi (JP)

(72) Inventor: Mutsumi MURAOKA, Komaki-shi (JP)

(73) Assignee: SUMITOMO RIKO COMPANY LIMITED, Komaki-shi (JP)

(21) Appl. No.: 18/663,587

(22) Filed: May 14, 2024

(30) Foreign Application Priority Data
Jun. 21, 2023 (JP) 2023-101773

(51) Int. Cl. F16F 13/10

(52) U.S. Cl. CPC F16F 13/105; F16F 2222/126

(57) ABSTRACT

A vibration-damping system including plural fluid-filled vibration-damping devices each including: a first mounting member and a second mounting member connected by a main rubber elastic body; a fluid chamber formed inside; a membrane partially constituting a wall of the fluid chamber; an action air chamber formed on an opposite side of the membrane to the fluid chamber; and a switching valve including a first port and a second port and communicating either the first port or the second port with the action air chamber by alternative switching, wherein the first port has a structure open to an air, and for each device, the second port alternatively has an obstruction structure of being sealed by an attached cap, or a suction structure of being connected to a negative pressure source to exert a negative pressure on the action air chamber.

### INCORPORATED BY REFERENCE

The disclosure of Japanese Patent Application No. 2023-101773 filed on Jun. 21, 2023 including the specification, drawings and abstract is incorporated herein by reference in its entirety.

### BACKGROUND ART

### 1. Technical Field

This disclosure relates to a vibration-damping system using a plurality of different fluid-filled vibration-damping devices with a fluid sealed therein, and especially relates to the vibration-damping system wherein each fluid-filled vibration-damping device includes an action air chamber and a switching valve connected to the action air chamber.

### 2. Description of the Related Art

Conventionally, there have been known fluid-filled vibration-damping devices, as vibration-damping devices like vibration-damping supports and vibration-damping connectors that are interposed between members of a vibration transmission system, to provide vibration-damping effect based on flow behavior including resonance action of a non-compressible fluid sealed inside the device. This fluid-filled vibration-damping device is proposed, for example, in U.S. Publication No. US 2007/138718.

In particular, the fluid-filled vibration-damping device described in US 2007/138718 has an action air chamber and a switching valve connected to the action air chamber, and it is configured as a negative pressure type fluid-filled vibration-damping device in which the action air chamber is alternatively connected to the air or to a prescribed negative pressure source by switching the switching valve. In this fluid-filled vibration-damping device, by switching the switching valve to change the vibration-damping characteristics in the vibration-damping device, vibration-damping effect is exerted for vibrations of multiple different frequencies.

### SUMMARY

By the way, in a vehicle using the fluid-filled vibration-damping device as described in, for example, US 2007/138718, by switching the switching valve to connect the action air chamber and the negative pressure source during idling, idling vibration may be suppressed by a vibration-damping mechanism having an orifice passage, etc. tuned to the frequency of idling vibration, etc., in the fluid-filled vibration-damping device. As the negative pressure source that is connected to the action air chamber, engine intake negative pressure may be employed, for example.

In recent years, however, vehicles with direct injection engines and idling stop vehicles and the like have increased, and there are cases where engine intake negative pressure cannot be employed as the negative pressure source. In such cases, a non-negative pressure type vibration-damping device may be adopted, but in many other cases, the negative pressure type vibration-damping device is still used. Thus, from the view of cost and environmental consideration, there has been a need for a vibration-damping system wherein the fluid-filled vibration-damping device is common between the negative pressure type and the non-negative pressure type.

When building the vibration-damping system using multiple fluid-filled vibration-damping devices in this way, it is necessary to tune the vibration-damping characteristics of the action air chamber in each fluid-filled vibration-damping device to the desired frequency, and a vibration-damping system wherein the spring characteristics can be tuned more easily has been sought.

It is therefore one object of the present disclosure to provide a vibration-damping system of novel structure which is able to use a fluid-filled vibration-damping device of common structure and desirably select either the negative pressure type or the non-negative pressure type to be installed in a vehicle.

It is another object of the present disclosure to provide a vibration-damping system of novel structure which is able to allow easy tuning of the spring characteristics of each action air chamber in a plurality of fluid-filled vibration-damping devices.

Hereinafter, preferred embodiments for grasping the present disclosure will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment provides a vibration-damping system comprising a plurality of fluid-filled vibration-damping devices each comprising: a first mounting member; a second mounting member; a main rubber elastic body connecting the first mounting member and the second mounting member; a fluid chamber formed inside; a membrane constituting a portion of a wall of the fluid chamber; an action air chamber formed on an opposite side of the membrane to the fluid chamber; and a switching valve including a first port and a second port and communicating either the first port or the second port with the action air chamber by alternative switching, wherein for any of the fluid-filled vibration-damping devices, the first port has a structure open to an air, and for each of the fluid-filled vibration-damping devices, the second port alternatively has an obstruction structure of being sealed by a cap being attached, or a suction structure of being connected to a negative pressure source to exert a negative pressure on the action air chamber.

According to this preferred embodiment, using fluid-filled vibration-damping devices of common structure, it is possible to freely select either the negative pressure type or the non-negative pressure type. That is, when the second port of the switching valve has a suction structure of being connected to the negative pressure source (e.g., engine intake negative pressure) to apply negative pressure to the action air chamber, this fluid-filled vibration-damping device is a conventional negative pressure type fluid-filled vibration-damping device. On the other hand, when the cap is attached to the second port of the switching valve and the second port has an obstruction structure wherein the action air chamber is sealed off by the cap, this fluid-filled vibration-damping device is a non-negative pressure type fluid-filled vibration-damping device without any negative pressure source (for example, engine intake negative pressure). In this way, the second port of the switching valve can have either a suction or obstruction structure, allowing the user to alternatively select the negative pressure type or the non-negative pressure type desirably, and the vibration-damping system according to this preferred embodiment has a common structure in not only the fluid-filled vibration-damping device but also the switching valve. In other words, in the vibration-damping system of this preferred embodiment, the fluid-filled vibration-damping devices of common structure even in the switching valve can be applied to a vehicle with the negative pressure source (e.g., engine intake negative pressure) and a vehicle without any negative pressure source (e.g., engine intake negative pressure).

A second preferred embodiment provides the vibration-damping system according to the first preferred embodiment, further comprising a switch control device controlling switching of the switching valve, wherein in any of the fluid-filled vibration-damping devices, the switch control device switches the switching valve by a same control.

According to this preferred embodiment, there is no need to change the switch control device of the switching valve whether it is the negative pressure type fluid-filled vibration-damping device (i.e., the second port has a suction structure) or the non-negative pressure type fluid-filled vibration-damping device (i.e., the second port has an obstruction structure), and the desired characteristics can be obtained in a common control mode both when the cap is attached and when the negative pressure source is connected.

A third preferred embodiment provides a vibration-damping system comprising a plurality of fluid-filled vibration-damping devices each comprising: a first mounting member; a second mounting member; a main rubber elastic body connecting the first mounting member and the second mounting member; a fluid chamber formed inside; a membrane constituting a portion of a wall of the fluid chamber; an action air chamber formed on an opposite side of the membrane to the fluid chamber; and a switching valve including a first port and a second port and communicating either the first port or the second port with the action air chamber by alternative switching, wherein for any of the fluid-filled vibration-damping devices, the first port is open to an air, for any of the fluid-filled vibration-damping devices, an obstruction tube is attached to the second port, and an end opening of the obstruction tube opposite to the second port is obstructed, and for each of the fluid-filled vibration-damping devices, a length of the obstruction tube is individually adjusted depending on required spring characteristics of the action air chamber.

According to this preferred embodiment, in the fluid-filled vibration-damping device wherein the obstruction tube is attached to the second port of the switching valve, when the switching valve is switched to connect the action air chamber to the second port, the internal spaces of the action air chamber, the second port, and the obstruction tube become a single space. Therefore, the internal volume of this single space can be adjusted by adjusting the length of the obstruction tube, and the characteristics of the action air chamber when the action air chamber is connected to the second port can be easily tuned utilizing the compressibility of the air in the obstruction tube.

A fourth preferred embodiment provides the vibration-damping system according to any one of the first through third preferred embodiments, wherein for any of the fluid-filled vibration-damping devices, an open tube is attached to the first port, for each of the fluid-filled vibration-damping devices, a length of the open tube is individually adjusted depending on the required spring characteristics of the action air chamber.

According to this preferred embodiment, in the fluid-filled vibration-damping device wherein the open tube is attached to the first port of the switching valve, when the switching valve is switched to connect the action air chamber to the first port, the internal spaces of the action air chamber, the first port, and the open tube become a single space. Therefore, the internal volume of this single space can be adjusted by adjusting the length of the open tube, and the characteristics of the action air chamber when the action air chamber is connected to the first port can be easily tuned utilizing the resonance phenomenon of the air in the open tube.

According to the present disclosure, it is possible to provide the vibration-damping system of novel structure wherein the fluid-filled vibration-damping devices of common structure are used, with the option of either the negative pressure type or the non-negative pressure type, which is able to be mounted on the vehicle.

According to another preferred embodiment of this disclosure, it is possible to provide the vibration-damping system of novel structure that allows easy tuning of the spring characteristics of each action air chamber in the plurality of fluid-filled vibration-damping devices.

### BRIEF DESCRIPTION OF THE DRAWINGS

The foregoing and/or other objects, features and advantages of the disclosure will become more apparent from the following description of a practical embodiment with reference to the accompanying drawings in which like reference numerals designate like elements and wherein:

FIG. 1 is a specific view for depicting and explaining a vibration-damping system in a first practical embodiment of the present disclosure;

FIG. 2 is an elevational view in axial or vertical cross section showing a fluid-filled vibration-damping device in the form of an engine mount constituting the vibration-damping system n shown in FIG. 1, showing the fluid-filled vibration-damping device with an obstruction structure in which a second port is obstructed by a cap;

FIG. 3 is an elevational view in axial or vertical cross section showing a fluid-filled vibration-damping device in the form of an engine mount constituting the vibration-damping system shown in FIG. 1, showing the fluid-filled vibration-damping device with a suction structure in which a negative pressure source is connected to a second port; and

FIG. 4 is a graph indicating the relationship between the length of a tube and spring characteristics in an action air chamber in the fluid-filled vibration-damping device constituting the vibration-damping system shown in FIG. 1.

### DETAILED DESCRIPTION

In order to further specifically clarify the present disclosure, the practical embodiment of the present disclosure will be described in detail below, with reference to the drawings.

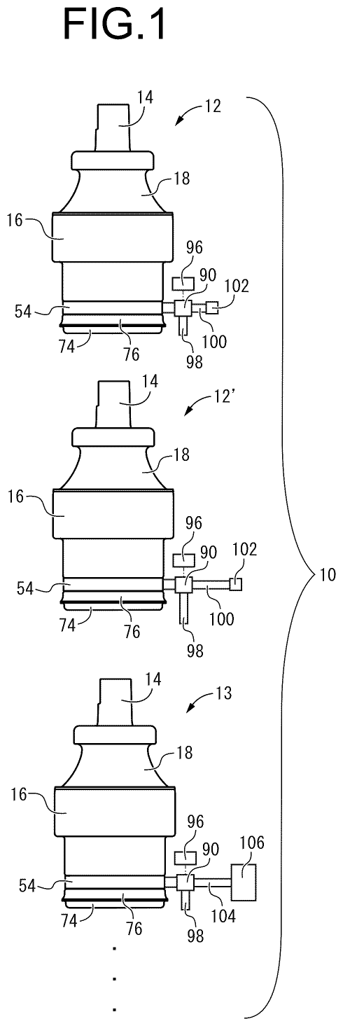

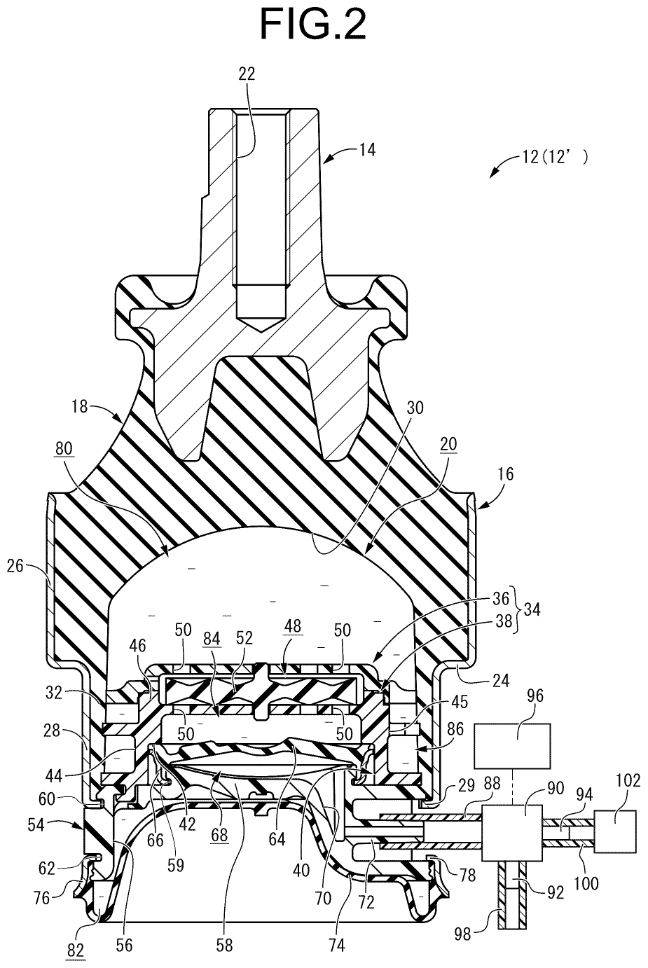

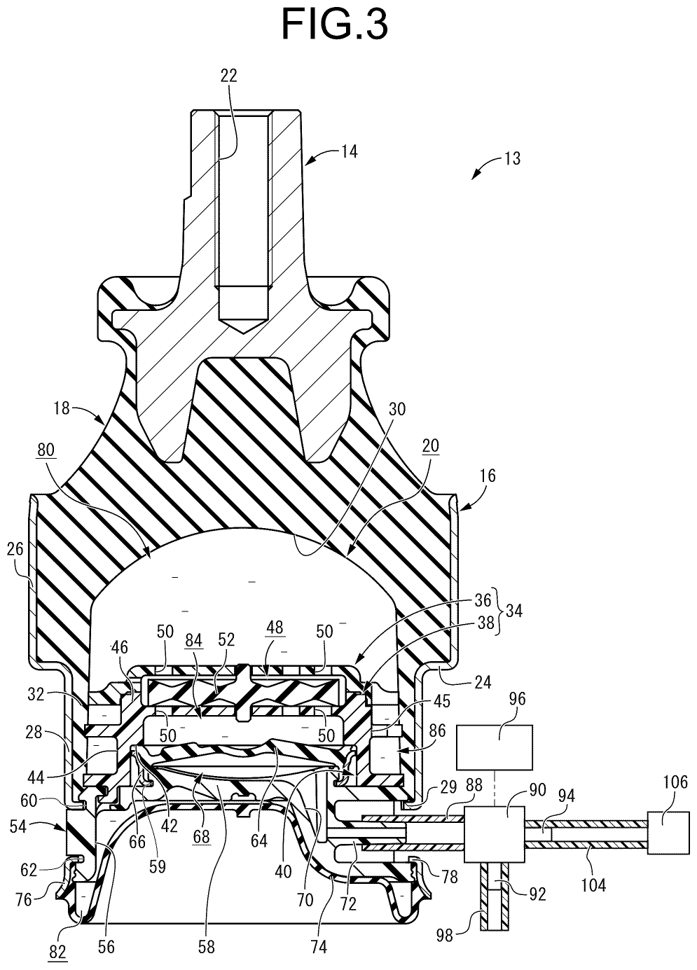

First, FIG. 1 shows a vibration-damping system 10 in a first practical embodiment of the present disclosure. This vibration-damping system 10 includes an engine mount 12 (12′), which is a non-negative pressure type fluid-filled vibration-damping device shown in FIG. 2, and an engine mount 13, which is a negative pressure type fluid-filled vibration-damping device shown in FIG. 3. These engine mounts 12 (12′), 13 have the same structure in many parts, and in the following explanation, the structure common to both engine mounts 12 (12′), 13 will be explained first. The basic structure of any of the engine mounts 12 (12′), 13 is that a first mounting member 14 and a second mounting member 16 are connected by a main rubber elastic body 18, and a fluid chamber 20 is formed inside the engine mount 12. Although both the engine mount 12 and the engine mount 12′ are non-negative pressure type, they are different from each other, in the length dimensions of an open tube 98 and an obstruction tube 100, which will be described below. In the following description, unless otherwise noted, the up-down direction means the up-down direction in FIG. 2, which is the mount axis direction.

More specifically, the first mounting member 14 has an approximately columnar shape extending in the up-down direction as a whole, and especially in this practical embodiment, the lower portion of the first mounting member 14 has a substantially cup shape opening downward. On the other hand, the upper portion of the first mounting member 14 is provided with a bolt hole 22 opening upward, into which a not-shown bolt is fastened. The first mounting member 14 integrally has an approximately cup-shaped part in the lower portion thereof and an approximately tubular part with the bolt hole 22 in the upper portion thereof.

The second mounting member 16 has a generally stepped, tubular shape as a whole. In the second mounting member 16, the upper portion than a step 24 formed in the axially middle portion thereof is a large-diameter tube part 26, and the lower portion than the step 24 is a small-diameter tube part 28. In the lower end of the small-diameter tube part 28, a roughly annular fitting projection 29 is formed projecting peripherally inward. The first mounting member 14 is spaced apart to the upper opening side in the second mounting member 16, and the central axes of the two members 14, 16 are located on substantially the same line, and the main rubber elastic body 18 is arranged between the first mounting member 14 and the second mounting member 16.

The main rubber elastic body 18 has a shape of substantially truncated cone as a whole, and almost all of the lower portion of the first mounting member 14 is adhered to the small diameter side end face of the main rubber elastic body 18 in a buried state. The outer peripheral surface of the large-diameter side end of the main rubber elastic body 18 is adhered to the inner peripheral surface of the large-diameter tube part 26 and the step 24 of the second mounting member 16. In this practical embodiment, the main rubber elastic body 18 is formed as an integrally vulcanization molded component incorporating the first mounting member 14 and the second mounting member 16. As a result, the first mounting member 14 and the second mounting member 16 are elastically connected by the main rubber elastic body 18, and the upper opening in the large-diameter tube part 26 of the second mounting member 16 is fluid-tightly closed by the main rubber elastic body 18.

A large-diameter recess 30 opening downward is formed in the large-diameter side end face of the main rubber elastic body 18. Moreover, a seal rubber layer 32 integrally formed with the main rubber elastic body 18 is adhered to the inner peripheral surface of the small-diameter tube part 28 of the second mounting member 16, with an approximately constant thickness dimension.

To the integrally vulcanization molded component of the main rubber elastic body 18 incorporating the first and second mounting members 14, 16, a partition member 34 is assembled from the lower opening side in the second mounting member 16. The partition member 34 of this practical embodiment is in a roughly cup shape that opens downward as a whole and is formed of a hard synthetic resin. In particular, in this practical embodiment, the partition member 34 is constituted by an upper lid member 36 and a lower partition member main body 38.

The partition member main body 38 has an outer diameter dimension smaller than the inner diameter dimension of the small-diameter tube part 28 in the second mounting member 16, and a central recess 40 opening downward is formed in the center portion on the lower surface of the partition member main body 38. The inner peripheral surface of the peripheral wall of the central recess 40 has an annular step face 42 that expands in the axis-perpendicular direction, which is positioned at a middle portion in the axial direction (the depth direction). As a result, the inner diameter dimension of the central recess 40 above the step face 42 is smaller than the inner diameter dimension thereof below the step face 42.

The peripheral wall of the partition member main body 38 has a peripheral groove 44 that opens on the outer peripheral surface and extends in a prescribed length in the peripheral direction. One end of the peripheral groove 44 opens upward through a communication window 45 provided at the upper end of the partition member main body 38, while the other end of the peripheral groove 44 opens downward through a not-shown communication window provided at the lower end of the partition member main body 38.

Furthermore, an annular protrusion 46 in a ring shape protruding upward is provided on the upper end face of the peripheral wall of the partition member main body 38. By so doing, an upwardly opening upper recess is formed on the inner peripheral side of the annular protrusion 46 in the upper end face of the partition member main body 38. The inner diameter dimension of the annular protrusion 46 is approximately equal to the inner diameter dimension of the central recess 40 above the step face 42. The upper opening of the upper recess is covered by the lid member 36 which is overlapped on the partition member main body 38 from above.

The lid member 36 has an approximately dish shape opening downward as a whole, and is overlapped on the upper end face of the annular protrusion 46 in the partition member main body 38 as the upper opening of the upper recess and the lower opening of the lid member 36 are butted against each other. The method of adhering the lid member 36 and the partition member main body 38 is not limited, and they can be adhered by welding, bonding, or the like. The space between the lid member 36 and the upper recess in the partition member main body 38 forms a restraining arrangement area 48.

In the partition member main body 38 and the lid member 36, a plurality of through holes 50 penetrating in the up-down direction are formed in the portions constituting the upper and lower walls of the restraining arrangement area 48. Through each of these through holes 50, the internal space of the restraining arrangement area 48 is connected to the external space on both sides in the up-down direction. A movable plate 52 made of an elastic material such as rubber, for example, is housed and arranged in the restraining arrangement area 48. The movable plate 52 has an approximately disc shape with a thin wall as a whole, and is located in the center portion of the restraining arrangement area 48. The dimension of the movable plate 52 in the up-down direction is smaller than the distance between the opposed surfaces of the upper and lower walls of the restraining arrangement area 48, so that the movable plate 52 can be displaced in the up-down direction inside the restraining arrangement area 48.

A fixing member 54 is overlapped on and assembled with the partition member 34, which consists of the lid member 36 and the partition member main body 38, from below in the axial direction. The fixing member 54 has an approximately disc shape as a whole and is formed of a hard synthetic resin. A lower recess 56 opening downward is provided in the center portion of the lower surface of the fixing member 54. A central protrusion 58 protruding upward is formed integrally in the central portion of the fixing member 54. A substantially circular recess opening upward is formed in the upper end face of the central protrusion 58. On the outer peripheral surface at the protrusion base end (the lower end) of the central protrusion 58, a fitting groove 59 is provided extending annularly over the entire periphery in the peripheral direction.

The upper end face of the fixing member 54 on the outer peripheral side of the central protrusion 58 is a generally annular flat surface that extends in the axis-perpendicular direction, and a not-shown communication hole that passes through in the up-down direction is formed in the periphery of the fixing member 54. This communication hole is formed at a position corresponding to the communication window at the other end of the peripheral groove 44, and communicates the upper side and the lower side (the lower recess 56) of the fixing member 54 with each other. In addition, an upper fitting groove 60 and a lower fitting groove 62 are formed on the outer peripheral face of the fixing member 54 at the upper and lower end portions, extending all the way around the peripheral direction.

This fixing member 54 is fixed to the partition member 34 by, for example, fitting the concave/convex portions provided in them. These concave/convex portions are formed, for example, with a certain peripheral length. By so doing, the upper end face of the fixing member 54 and the lower end face of the partition member 34 are overlapped substantially with no gap between them.

To the central protrusion 58 of the fixing member 54, a membrane 64 is assembled. The membrane 64 is in an approximately disc shape with a thin wall as a whole, and is formed of an elastic material such as rubber. Both surfaces of the membrane 64 have a plurality of bumps, grooves, ridges, and the like and the thickness dimension of the membrane 64 varies in the peripheral direction. A generally tubular fitting ring 66 is adhered to the outer peripheral end of the membrane 64. In this practical embodiment, the membrane 64 is formed as an integrally molded component with the fitting ring 66. The lower end of the fitting ring 66 is bent toward the inner periphery, and the lower end of the fitting ring 66 is inserted into the fitting groove 59 in the central protrusion 58, so that the membrane 64 is assembled to the fixing member 54 so as to cover the upper opening in the central protrusion 58.

An action air chamber 68 is formed between the bottom of the central protrusion 58 and the membrane 64. An air passage 70 is formed through the fixing member 54. One end of the air passage 70 opens on the upper face of the central protrusion 58 and is connected to the action air chamber 68, while the other end of the air passage 70 opens on the outer peripheral face of the fixing member 54. The other end of the air passage 70 is an approximately tubular port part 72, which projects from the outer peripheral face of the fixing member 54 to the outer peripheral side.

The fixing member 54 with the membrane 64 assembled to the central protrusion 58 thereof is assembled to the partition member 34 from below, so that the outer peripheral end of the membrane 64 and the upper end of the fitting ring 66 are overlapped on the step face 42 in the central recess 40 provided at the lower side of the partition member 34. As a result, the central recess 40, which opens downward in the partition member 34, is covered by the membrane 64.

The assembly of the fixing member 54 and the partition member 34 is inserted through the lower opening of the second mounting member 16, and the fitting projection 29 at the lower end of the second mounting member 16 is fitted into the upper fitting groove 60 in the fixing member 54, thereby assembling the fixing member 54 and the partition member 34 to the second mounting member 16. Thus, the second mounting member 16 is externally fitted and fixed to the upper end of the fixing member 54.

Furthermore, a diaphragm 74 is assembled to the lower end of the fixing member 54 exposed from the lower end of the second mounting member 16. The diaphragm 74 has a thin-walled disc shape as a whole, and is formed of an elastic material such as rubber to readily allow flexural deformation. An approximately tubular fixation fitting 76 is fixed to the outer peripheral end of the diaphragm 74. To the upper end of the fixation fitting 76, a generally annular fitting projection 78 is formed projecting toward the inner periphery. The fixation fitting 76 is fitted externally on the fixing member 54 and the fitting projection 78 is inserted in the lower fitting groove 62 in the fixing member 54. By so doing, the diaphragm 74 is assembled to the lower portion of the fixing member 54. As a result, the opening of the lower recess 56 in the fixing member 54 is fluid-tightly covered by the diaphragm 74. In short, the lower opening of the second mounting member 16 is covered by the diaphragm 74 via the fixing member 54, and the partition member 34 and the fixing member 54 are arranged between the axially opposite faces of the main rubber elastic body 18 and the diaphragm 74.

Thus, the fluid chamber 20 sealed against the external space is formed between the opposed faces of the main rubber elastic body 18 and the diaphragm 74, and a non-compressible fluid is sealed in the fluid chamber 20. For example, water, alkylene glycol, polyalkylene glycol, silicone oil, etc. are employed as the sealed fluid or liquid, but it is desirable to employ a fluid with low viscosity of 0.1 Pa·s or less in order to effectively obtain the vibration-damping effect based on the fluid's resonance action and other flow effects, in particular.

As described above, the partition member 34 and the fixing member 54 are arranged inside the fluid chamber 20 so that the partition member 34 and the fixing member 54 expand in the axis-perpendicular direction, and the fluid chamber 20 is bisected into upper and lower sections in the axial direction by the partition member 34 and the fixing member 54. In the fluid chamber 20, above the partition member 34 and the fixing member 54, there is formed a primary liquid chamber 80 whose wall is partially constituted by the main rubber elastic body 18. In the primary liquid chamber 80, pressure fluctuations occur based on elastic deformation of the main rubber elastic body 18 during vibration input between the first mounting member 14 and the second mounting member 16. On the other hand, below the partition member 34 and the fixing member 54 in the fluid chamber 20, there is formed an equilibrium chamber 82 whose wall is partially constituted by the diaphragm 74, wherein volume change is easily allowed by the deformation of the diaphragm 74.

As mentioned above, the lower opening of the central recess 40 in the partition member main body 38 is covered with the membrane 64, and an auxiliary liquid chamber 84 is formed between the partition member main body 38 and the membrane 64. This auxiliary liquid chamber 84, like the primary liquid chamber 80 and the equilibrium chamber 82, is filled with the non-compressible fluid, and the fluid chamber 20 is partially constituted by the auxiliary liquid chamber 84. As a result, a portion of the wall of the fluid chamber 20 is constituted by the membrane 64. The auxiliary liquid chamber 84 is configured above the membrane 64 while the action air chamber 68 is configured below the membrane 64. In other words, the action air chamber 68 is formed on the opposite side of the membrane 64 to the fluid chamber 20 (the auxiliary liquid chamber 84).

Furthermore, the primary liquid chamber 80 and the auxiliary liquid chamber 84 are partitioned in the up-down direction by the restraining arrangement area 48 in the partition member 34, and in the restraining arrangement area 48, the movable plate 52 is disposed so that it can be displaced by a prescribed amount in the up-down direction. The pressure of the primary liquid chamber 80 and the auxiliary liquid chamber 84 is exerted respectively on the upper and lower surfaces of the movable plate 52, through the plurality of through holes 50. During vibration input, pressure fluctuations in the primary liquid chamber 80 are made to escape to the auxiliary liquid chamber 84, based on fluctuations in the relative pressure differences between the primary liquid chamber 80 and the auxiliary liquid chamber 84.

The partition member 34 and the fixing member 54 are assembled to the second mounting member 16, and the outer peripheral side opening of the peripheral groove 44 in the partition member main body 38 is fluid-tightly covered by the small-diameter tube part 28 in the second mounting member 16 via the seal rubber layer 32, thereby forming an orifice passage 86. One end of the orifice passage 86 is connected to the primary liquid chamber 80 through the communication window 45 of the partition member main body 38. The other end of the orifice passage 86 is connected to the equilibrium chamber 82 through a communication window and a connection hole in the partition member main body 38 and the fixing member 54, which are not shown. As a result, the primary liquid chamber 80 and the equilibrium chamber 82 are connected to each other by the orifice passage 86, and fluid flow is allowed between the two chambers 80, 82 through the orifice passage 86. The orifice passage 86 is tuned so that the resonance frequency of the fluid flowing in the orifice passage 86 exhibits effective vibration-damping effect (vibration isolation effect on the basis of low dynamic spring characteristics) against vibrations in the frequency range corresponding to idling vibration, etc. (e.g., about several tens of Hz) based on the resonance action of the fluid.

In the engine mount 12 (or the engine mount 12′, 13) of such construction, the first mounting member 14 is fixed to a member on the power unit side by a not-shown bolt, which is fastened in the bolt hole 22, and the large-diameter tube part 26 of the second mounting member 16 is secured to a not-shown bracket and fixed to a member on the vehicle body side. Thus, the engine mount 12 (or the engine mount 12′, 13) is mounted between the power unit and the vehicle body to provide vibration-damping support for the power unit in relation to the vehicle body.

Here, an air pipeline 88 is connected to the port part 72 in the fixing member 54, and through the air pipeline 88, the internal space of the port part 72, the air passage 70, and the action air chamber 68 is connected to a switching valve 90. The switching valve 90 is a three-way valve provided with a first port 92 and a second port 94, wherein switching is controlled by a switch control device 96 installed in the vehicle, and either the first port 92 or the second port 94 is selected and connected to the port part 72 and the air pipeline 88. Specifically, the switching valve 90 is also an electromagnetic valve that is switched electromagnetically, for communicating either the first port 92 or the second port 94 with the action air chamber 68 by alternative switching.

The switch control device 96 is designed to receive inputs from various sensors, etc. installed in the car, of various information expressing the state of the car, such as the speed of the car, engine speed, reduction gear selection position, throttle opening degree, etc., as required. Based on such information, and in accordance with a preset program, the switching valve 90 is switched and activated by the software of the microcomputer or the like. By switching and controlling the switching valve 90 appropriately according to the vibration input under various conditions, such as the driving condition of the car, the pressure of the action air chamber 68 is controlled to achieve the desired vibration-damping effect. In this practical embodiment, all of the non-negative pressure type engine mounts 12 (12′) and the negative pressure type engine mount 13 are equipped with the switch control device 96, and the switching valve 90 is switched by the control by the switch control device 96.

The open tube 98 is connected to the first port 92 in the switching valve 90, and the open tube 98 is open to the air. In other words, the first port 92 has a structure open to the air, for any of the engine mounts 12 (12′), 13.

The common structure for the engine mounts 12 (12′), 13 was described above. The following is an explanation of the difference between the non-negative pressure type engine mount 12 (12′) shown in FIG. 2 and the negative pressure type engine mount 13 shown in FIG. 3.

In the engine mount 12 (12′) shown in FIG. 2, the obstruction tube 100 is connected to the second port 94 and a cap 102 is attached to the end opening opposite the side connected to the second port 94 in the obstruction tube 100. The obstruction tube 100 and the cap 102 may be made of synthetic resin, for example, respectively, and have a certain degree of deformation rigidity. The structure for fixing the obstruction tube 100 and the cap 102 is not limited and may be adhesive, welding, etc. However, for example, it is possible to provide a male thread on the outer peripheral face of the end opening on the side to which the cap 102 is attached in the obstruction tube 100, and a female thread on the inner peripheral face of the cap 102 so that by screwing of these male thread and female thread the cap 102 is attached to the end opening of the obstruction tube 100 to close the obstruction tube 100. Additionally, the obstruction tube 100 has some length dimension.

In this structure, when the switching valve 90 is switched by the switch control device 96 to connect the air pipeline 88 (the port part 72) and the second port 94, the internal space of the action air chamber 68, the air passage 70, the port part 72 and the air pipeline 88 is connected to the internal space of the obstruction tube 100. By securing the cap 102 to the end of the obstruction tube 100, the internal space becomes a sealed space, preventing or inhibiting volume changes, and the membrane 64 exhibits harder spring rigidity than when the action air chamber 68 is open to the air through the open tube 98. In such a case, the second port 94 has an obstruction structure of being sealed by the cap 102 being attached to the obstruction tube 100 connected to the second port 94.

On the other hand, in the engine mount 13 shown in FIG. 3, a connection tube 104 is connected to the second port 94, and a negative pressure source 106 is attached to the end of the connection tube 104 opposite the side connected to the second port 94. As this negative pressure source 106, for example, engine intake negative pressure can be used.

In such a structure, when the switching valve 90 is switched by the switch control device 96 and the air pipeline 88 (the port part 72) and the second port 94 are connected, by exerting a suction force from the negative pressure source 106, the membrane 64 is suctioned and deformed by negative pressure toward the action air chamber 68, or even more strongly suctioned to be overlapped on the bottom face of the action air chamber 68, so that the deformation of the membrane 64 is constrained, thus exhibiting hard spring rigidity. In this case, the second port 94 is connected to the negative pressure source 106 via the connection tube 104 and has a suction structure where negative pressure is exerted on the action air chamber 68.

Upon input of vibration, such as idling vibration for example, to the engine mounts 12 (12′), 13 as described above, pressure fluctuation of relatively large amplitude is induced in relation to the primary liquid chamber 80. In this case, in each engine mount 12 (12′), 13, the switching valve 90 is switched by the switch control device 96 to connect the air pipeline 88 and the second port 94 (the cap 102 or the negative pressure source 106), thereby preventing or suppressing deformation of the auxiliary liquid chamber 84. This inhibits pressure fluctuations in the primary liquid chamber 80 from escaping into the auxiliary liquid chamber 84, and the flow of fluid through the orifice passage 86, which is tuned to idling vibration, exhibits good vibration-damping effect.

In particular, in the non-negative pressure type engine mount 12 (12′) shown in FIG. 2, the volume of the sealed space including the action air chamber 68 is determined by the internal space of the air passage 70, the port part 72, the air pipeline 88 and the obstruction tube 100, in addition to the action air chamber 68 as described above. That is, the volume of such sealed space can be adjusted by setting the obstruction tube 100 to an appropriate length. The rigidity of the membrane 64 is determined by the volume of this sealed space, as the air spring in such sealed space (internal space) acts as an auxiliary or constraining spring for the membrane 64.

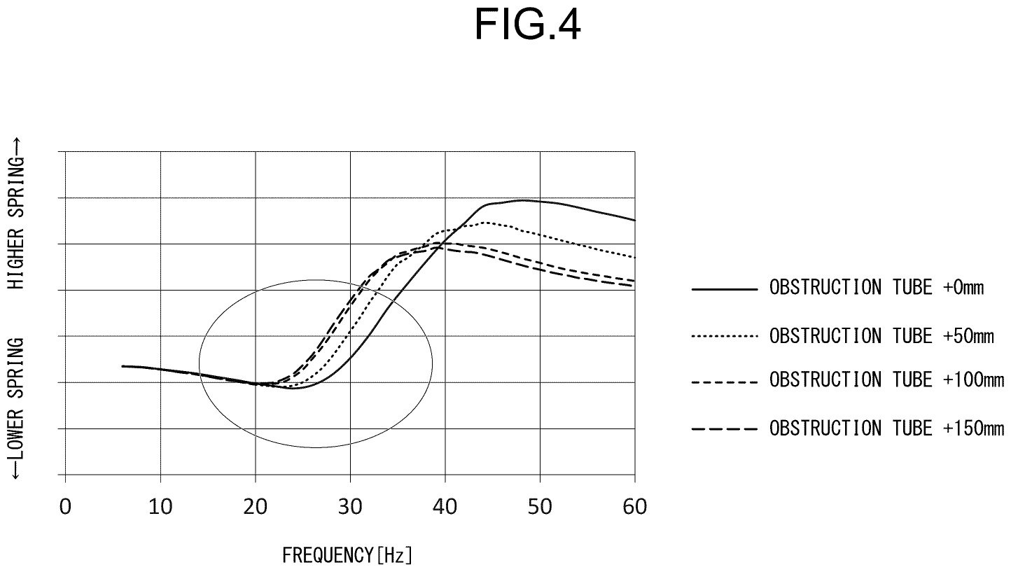

The inventor actually prepared a plurality of obstruction tubes 100 of different lengths, fabricated the plurality of engine mounts 12, 12′ with the obstruction tubes 100 of different lengths, and determined the spring characteristics of the action air chamber 68 (the rigidity of the membrane 64) in each engine mount 12, 12′, and the frequency characteristics of the vibration-damping characteristics (absolute spring constant) of the engine mounts 12, 12′ based on the resonance action of the fluid flowing through the orifice passage 86, which varies with the spring characteristics of the action air chamber 68. In this experiment, a reference obstruction tube (obstruction tube+0 mm), an obstruction tube with 50 mm extension (obstruction tube+50 mm), an obstruction tube with 100 mm extension (obstruction tube+100 mm), and an obstruction tube with 150 mm extension (obstruction tube +150 mm) in comparison with the reference obstruction tube were prepared. The resultant graph is shown in FIG. 4. In the graph in FIG. 4, the vertical axis shows the absolute spring constant of the engine mounts 12, 12′ (in particular, the main rubber elastic body 18) on a linear scale (normal scale). As it goes upper on the vertical axis, it means the spring constant goes higher, while as it goes lower on the vertical axis, it means the spring constant goes lower. As is clear from the circled area in FIG. 4, the volume of the sealed space including the action air chamber 68 also changes as the length of the obstruction tube 100 varies, and the spring characteristics of the membrane 64 (the rigidity of the membrane 64) change, and thus the resonance bottom frequency changes in the spring characteristics of the engine mounts 12, 12′, based on the flow action of the fluid flowing through the orifice passage 86. Specifically, the resonance bottom frequency becomes lower by making the obstruction tube 100 longer. By setting the length dimension of the obstruction tube 100 appropriately, it is possible to adjust the resonance bottom frequency in the spring characteristics of the engine mounts 12, 12′ based on the flow action of the fluid flowing through the orifice passage 86 to the desired value. In the negative pressure type engine mount 13, a roughly constant suction restraining force is applied to the membrane 64, and the length dimension of the connection tube 104 rarely affects the spring characteristics of the action air chamber 68. Thus, the length dimension of the connection tube 104 is set to an appropriate length in consideration of its handle, etc. Therefore, the same tube as the obstruction tube 100 employed in the non-negative pressure type engine mount 12 (12′), for example, can be employed as the connection tube 104.

On the other hand, when high-frequency small-amplitude vibration

such as booming noise is input to the engine mount 12 (12′), 13, the switching valve 90 is switched to connect the air pipeline 88 to the first port 92. Since the first port 92 is connected to the air through the open tube 98, the membrane 64 exhibits relatively soft spring characteristics. As a result, the pressure fluctuation of the primary liquid chamber 80 is efficiently transmitted to the auxiliary liquid chamber 84 as the movable plate 52 is displaced within the restraining arrangement area 48, and the pressure fluctuation of the primary liquid chamber 80 is reduced or eliminated by the liquid pressure absorption action based on the elastic deformation of the membrane 64, resulting in good vibration-damping effect. Upon input of the high-frequency small-amplitude vibration, the orifice passage 86, which is tuned to a lower frequency range, is substantially closed due to a significant increase in fluid flow resistance by antiresonance action.

As shown in FIG. 1, by setting the appropriate length dimension of the open tube 98, it is possible to change the volume of the internal space from the action air chamber 68 to the external space when the air pipeline 88 and the first port 92 are connected. Also by so doing, it is possible to adjust the spring characteristics of the membrane 64, that is, of the action air chamber 68. As a result, in the vibration-damping mechanism using fluid flow via the through holes 50 between the primary liquid chamber 80 and the auxiliary liquid chamber 84, the resonance frequency can be tuned by varying the length dimension of the open tube 98.

According to the vibration-damping system 10 of this preferred embodiment having the above-mentioned configuration, the engine mount 12 (12′) shown in FIG. 2 can be employed for vehicles that do not have the negative pressure source 106 (e.g., engine intake negative pressure), and the engine mount 13 shown in FIG. 3 can be employed for vehicles that have the negative pressure source 106 (e.g., engine intake negative pressure). These engine mounts 12, 12′, 13 have the same structure in many parts. Specifically, in the engine mounts 12, 12′, the obstruction tube 100 and the cap 102 are connected to the second port 94, and in the engine mount 13, the connection tube 104 and the negative pressure source 106 are connected to the second port 94. In short, by selecting whether the second port 94 has an obstruction or suction structure, and by connecting either the cap 102 or the negative pressure source 106 to the tube connected to the second port 94 (the obstruction tube 100 or the connection tube 104), it is possible to freely select the non-negative pressure type engine mount 12 (12′) or the negative pressure type engine mount 13. As a result, the engine mount 12 (12′) having the obstruction structure with the cap 102 connected to the second port 94 via the obstruction tube 100 and the engine mount 13 having the suction structure with the negative pressure source 106 connected to the second port 94 via the connection tube 104 are combined to construct the vibration-damping system 10. In this way, it is possible to readily deal with both vehicles without the negative pressure source 106 (e.g., engine intake negative pressure) and vehicles with the negative pressure source 106 (e.g., engine intake negative pressure) efficiently and at low cost.

In particular, the same switch control device 96 for switching the switching valve 90 can be used for both the non-negative pressure type engine mount 12 (12′) and the negative pressure type engine mount 13. Also, it is not necessary to change the switch control device 96 when selecting the non-negative pressure type engine mount 12 (12′) or the negative pressure type engine mount 13. As a result, even the control system can be had in common in each practical embodiment, and it is possible to deal with both the vehicles without the negative pressure source 106 and the vehicles with the negative pressure source 106 by simply changing the connection destination from the cap 102 to the negative pressure source 106, or vice versa, without any major changes.

In the non-negative pressure type engine mounts 12, 12′, the spring characteristics in the action air chamber 68 when the air pipeline 88 (the port part 72) is connected to the second port 94 are adjusted by varying the length dimension of the obstruction tube 100 connected to the second port 94. This makes it possible to easily tune the resonance frequency in a vibration-damping mechanism equipped with, for example, the orifice passage 86, etc. By preparing the plurality of obstruction tubes 100 with different lengths, the plurality of non-negative pressure type engine mounts 12, 12′ with different spring characteristics of the action air chamber 68 can be employed in various vehicles without the negative pressure source 106 (e.g., engine intake negative pressure). This makes it possible to configure the vibration-damping system 10 with the plurality of non-negative pressure type engine mounts 12, 12′ having the obstruction tubes 100 with different lengths and the negative pressure type engine mount 13.

Similarly, by varying the length dimension of the open tube 98 connected to the first port 92, the spring characteristics in the action air chamber 68 when the air pipeline 88 (the port part 72) is connected to the first port 92 are adjusted. This makes it possible to easily tune the resonance frequency in the vibration-damping mechanism using flow, etc. between the primary liquid chamber 80 and the auxiliary liquid chamber 84 in any of the engine mounts 12 (12′), 13, whether non-negative pressure type or negative pressure type. By so doing, it is possible to constitute the vibration-damping system 10 having the plurality of engine mounts 12, 12′, 13 whose resonance frequencies are set to desired values.

Although one embodiment of the present disclosure has been described in detail above, it goes without saying that the present disclosure is not limited in any way by the specific description in this practical embodiment, but can be implemented with various changes, modifications, improvements, etc. based on the knowledge of those skilled in the art, and any such practical embodiment is included within the scope of this disclosure as long as it does not depart from the intent of this disclosure.

For example, in the aforesaid practical embodiment, the primary liquid chamber 80 and the equilibrium chamber 82 are connected by the orifice passage 86 and the vibration-damping mechanism utilizing the orifice passage 86 is tuned to medium-frequency medium-amplitude vibration corresponding to idling vibration, while the vibration-damping mechanism using the primary liquid chamber 80 and the auxiliary liquid chamber 84 is tuned to high-frequency small-amplitude vibration corresponding to booming noise, but it is not limited to this preferred embodiment. That is, for example, the fluid-filled vibration-damping device may be applied to other devices than engine mounts, and vibration other than idling vibration and booming noise shown as examples in the above-described practical embodiment may be suppressed. In the fluid-filled vibration-damping device, vibration to be damped is not limited (in terms of frequency, amplitude, etc.). The device will do as long as the vibration-damping effect is exerted against at least one of various types of vibration, such as low-frequency large-amplitude vibration, medium-frequency medium-amplitude vibration, and high-frequency small-amplitude vibration, for example. Moreover, the number of orifice passages is not limited, and two or more orifice passages can be provided depending on the vibration to be damped. For example, in the engine mount having the basic structure in the above-mentioned practical embodiment, it is possible to provide a second orifice passage that connects the primary liquid chamber and the auxiliary liquid chamber, and to tune the second orifice passage to a frequency range different from that of the first orifice passage. The flow characteristics of the fluid flowing through the second orifice passage, and hence the vibration-damping characteristics exhibited by the second orifice passage, can also be adjusted appropriately by changing the spring rigidity of the membrane that forms a portion of the wall of the auxiliary liquid chamber by switching the switching valve. Such second orifice passage should be tuned to a higher frequency range than that of the first orifice passage. In the fluid-filled vibration-damping device of the present disclosure, the orifice passage connecting the primary liquid chamber and the equilibrium chamber, including the equilibrium chamber, is not essential. It is also possible that, in a fluid-filled vibration-damping device without the equilibrium chamber, for example, fluid flow through the orifice passage connecting the primary liquid chamber and the auxiliary liquid chamber damps low-frequency large-amplitude vibration (e.g., engine shake) and middle-frequency middle-amplitude vibration (e.g., idling vibration), and the vibration-damping characteristics may be changed and set based on switching of the switching valve. The specific control mode of switching operation of the switching valve may be set as appropriate according to the vibration mode to be damped, input conditions, etc., and it is not limited.

In the aforesaid practical embodiment, the obstruction tube 100 is obstructed by attaching the cap 102 at the end opening of the obstruction tube 100 opposite the side connected to the second port 94. However, in some preferred embodiment of the present disclosure without any cap, the obstruction tube may be closed by welding or bonding the inner peripheral surface of the obstruction tube, for example, or alternatively the end opening of the obstruction tube may be closed by filling it with a different material. The method of securing the obstruction tube 100 and the cap 102 is not limited to screwing of the male and female threads shown as an example in the previous practical embodiment, but it may be, for example, press-fit or concave/convex fitting, etc.

Furthermore, in the aforesaid practical embodiment, the engine mounts 12, 12′ are shown as examples of fluid-filled vibration-damping devices and the engine intake negative pressure is shown as an example of the negative pressure source 106, but they are not limited to this preferred embodiment. The fluid-filled vibration-damping device may be a fluid-filled vibration-damping device for vehicles other than engine mounts, such as body mounts and differential mounts, or a fluid-filled vibration-damping device for other than vehicles. Similarly, the negative pressure source employed in the fluid-filled vibration-damping device may be a negative pressure source installed in the vehicle other than the engine intake negative pressure, or a negative pressure source installed in other than the vehicle.

The fluid-filled vibration-damping device according to the present disclosure need only have, for example, the action air chamber and the switching valve connected to the action air chamber. It is possible whether or not the obstruction tube and/or the cap connected to the second port of the switching valve in the fluid-filled vibration-damping device constitute the fluid-filled vibration-damping device.

In the above-said practical embodiment, the vibration-damping system 10 comprises the plurality of non-negative pressure type engine mounts 12, 12 with the obstruction tubes 100 with different length dimensions and the negative pressure type engine mount 13, but it is not limited to this preferred embodiment. In one preferred embodiment of the vibration-damping system of the present disclosure, the length dimensions of the obstruction tubes in the non-negative pressure type engine mounts may be constant, and the vibration-damping system may be configured by combining such non-negative pressure type engine mounts and the negative pressure type engine mount. In another preferred embodiment of the vibration-damping system according to the present disclosure, the negative pressure type engine mount is not essential, and the vibration-damping system may be constituted by the plurality of non-negative pressure type engine mounts including the obstruction tubes with mutually different length dimensions.

What is claimed is:

1. A vibration-damping system comprising a plurality of fluid-filled vibration-damping devices each comprising:
a first mounting member;
a second mounting member;
a main rubber elastic body connecting the first mounting member and the second mounting member;
a fluid chamber formed inside;
a membrane constituting a portion of a wall of the fluid chamber;
an action air chamber formed on an opposite side of the membrane to the fluid chamber; and
a switching valve including a first port and a second port and communicating either the first port or the second port with the action air chamber by alternative switching, wherein
for any of the fluid-filled vibration-damping devices, the first port has a structure open to an air, and
for each of the fluid-filled vibration-damping devices, the second port alternatively has an obstruction structure of being sealed by a cap being attached, or a suction structure of being connected to a negative pressure source to exert a negative pressure on the action air chamber.

2. The vibration-damping system according to claim 1, further comprising a switch control device controlling switching of the switching valve, wherein
in any of the fluid-filled vibration-damping devices, the switch control device switches the switching valve by a same control.

3. A vibration-damping system comprising a plurality of fluid-filled vibration-damping devices each comprising:
a first mounting member;
a second mounting member;
a main rubber elastic body connecting the first mounting member and the second mounting member;
a fluid chamber formed inside;
a membrane constituting a portion of a wall of the fluid chamber;
an action air chamber formed on an opposite side of the membrane to the fluid chamber; and
a switching valve including a first port and a second port and communicating either the first port or the second port with the action air chamber by alternative switching, wherein
for any of the fluid-filled vibration-damping devices, the first port is open to an air,
for any of the fluid-filled vibration-damping devices, an obstruction tube is attached to the second port, and an end opening of the obstruction tube opposite to the second port is obstructed, and
for each of the fluid-filled vibration-damping devices, a length of the obstruction tube is individually adjusted depending on required spring characteristics of the action air chamber.

4. The vibration-damping system according to claim 1, wherein
for any of the fluid-filled vibration-damping devices, an open tube is attached to the first port,
for each of the fluid-filled vibration-damping devices, a length of the open tube is individually adjusted depending on the required spring characteristics of the action air chamber.

5. The vibration-damping system according to claim 3, wherein
for any of the fluid-filled vibration-damping devices, an open tube is attached to the first port,
for each of the fluid-filled vibration-damping devices, a length of the open tube is individually adjusted depending on the required spring characteristics of the action air chamber.
